(19) United States
(12) Patent Application Publication
(10) Pub. No.: US 2016/0308838 A1
(43) Pub. Date: Oct. 20, 2016

(54) DIGITAL SWITCHBOARD

(71) Applicant: HEWLETT PACKARD ENTERPRISE DEVELOPMENT LP, Houston, TX (US)

(72) Inventors: Gearoid Patrick Murphy, Galway (IE); Steven Joseph Roscio, Colorado Springs, CO (US); Michael Spratte, Colorado Springs, CO (US); Paul D Vencel, Fort Collins, CO (US)

(21) Appl. No.: 15/102,973

(22) PCT Filed: Dec. 20, 2013
(86) PCT No.: PCT/US2013/076960

§ 371 Date: Jun. 9, 2016

(51) Int. Cl. H04L 29/06; H04L 12/04

(52) U.S. Cl. CPC H04L 63/0281; H04L 63/10; H04L 12/04

(57) ABSTRACT

An example system includes at least one switchboard node coupled to a network, a first device coupled to the network and a second device coupled to the network. The first device may send a request for a service, the requested service being one of a plurality of offered services. The request for the service may be associated with the second device. The switchboard node may be to receive the request for service; identify security requirements associated with the requested service, the security requirements being at least one security requirement from a plurality of security requirements, wherein different ones of the plurality of offered services are associated with different ones of the plurality of security requirements; determine that the identified security requirements are satisfied; and fulfill the request for the service upon determining that the identified security requirements are satisfied.

### BACKGROUND

Modern computer products come in a variety of forms with a wide range of capabilities. Supporting this variety of products with digital services may include using different infrastructure and different security protocols depending on the type of product and/or service being supported. In addition, different security protocols may be dependent on a user's identity, and the confidence in the user's identity may be a changing quantity. One of the obstacles to deploying different types of products within networks of security conscious customers is a resistance to changes in firewall configurations necessary to access digital support content with different types of products and different users.

### BRIEF DESCRIPTION OF THE DRAWINGS

For a more complete understanding of various examples, reference is now made to the following description taken in connection with the accompanying drawings in which:

FIG. 1 illustrates an example system that may be used for interconnecting consumers and producers of digital services;

FIG. 2A illustrates an example process that may be used for interconnecting consumers and producers of digital services;

FIG. 2B illustrates another example process that may be used for interconnecting consumers and producers of digital services; and

FIG. 3 illustrates example functions that may be performed during security requirement assessment while interconnecting consumers and producers of digital services.

### DETAILED DESCRIPTION

Example systems and methods described herein provide for a switchboard network through which digital services may be requested and transmitted for the purpose of automated product support and other services. The systems described herein may include a cloud-based switchboard mechanism, which links connected user devices to appropriate digital service devices. The example systems and methods may be optimized so many diverse product families can utilize the same digital switchboard infrastructure to access support services, thus reducing product development time across large enterprises by sharing the same software stack for product support and other services.

An inherent consequence of supporting large numbers of customer devices is that the ownership of a given device may change unpredictably over time. The example switchboard network described herein may cater to this changing landscape through the use of dynamic levels of trust. Devices which provide relatively little identifying information may still be afforded access to essential update services(such as security patches) but may be restricted from more costly support services (such as logging stream analysis). If the user chooses to provide more details, the confidence in the identity of the device and user may increase thus permitting access to additional support services.

Access to support services by remote user devices may he dynamically restricted based on the trust placed in a device due to the authenticity of its identifying credentials. By relaxing constraints on how support content is described (e.g., using simple text key/value attributes instead of formal protocol specifications), new product lines may he quickly and easily supported with the same infrastructure with a minimum of code refactoring.

In summary, a switchboard network in accordance with the disclosure may provide a flexible connectivity model between a service provider and end products to enable a secure framework for the provision of services such as product support, automated firmware/software upgrades, functionality enablement, fault & diagnostics, telemetry data reporting and many more services. ho addition, the example switchboard network may provide an ability to support many different products within the same infrastructure while decoupling dependency of the switchboard network on backend databases systems, thus reducing failure propagation and increasing reliability.

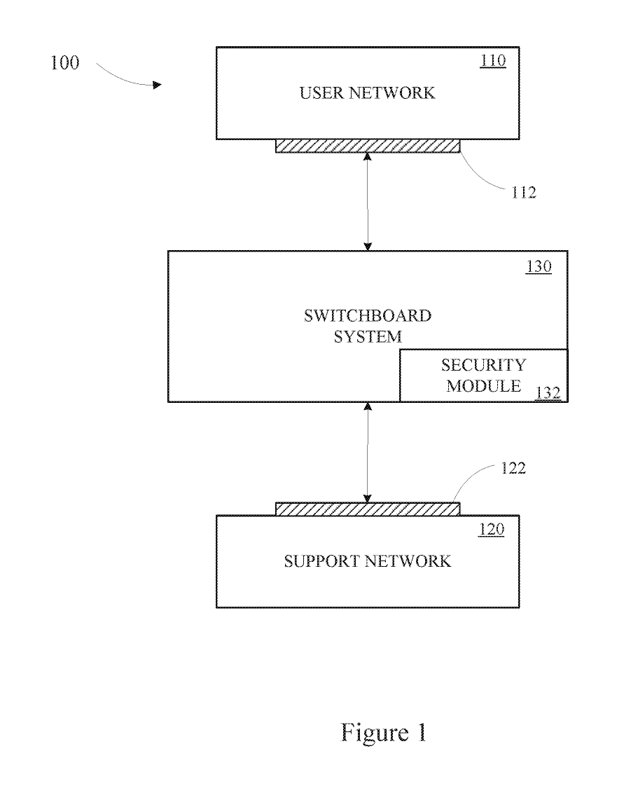

FIG. 1 illustrates an example system 100 that may be used for interconnecting user devices and service devices of producers of digital services. The system 100 includes a user network 110 and a support network 120, each coupled to a switchboard system 130. The user network 110 may include a plurality of user devices (not shown) of different types connected to the user network 110. For example, the user devices may include mobile devices such as smart phones, tablet computers, lap top computers, etc., and non-mobile devices such as desktop computers, routers, printers, database servers etc.

A user firewall 112 is located between the user network 110 and the switchboard system 130. The user firewall 112 provides various security protocols to protect information transferred between the various user devices of the user network, the switchboard system 130 and the support network 120.

The support network 120 may include application server computers, support agent computers, and other devices, both mobile and non-mobile devices, referred to collectively as service devices (not shown) A service firewall 122 is located between the support network 120 and the switchboard system 130. The service firewall 12 provides security protocols to protect information transferred between the various service devices of the support network 120, the switchboard system 130 and the user network 120.

The switchboard system 130 may include a plurality of switchboard nodes, not shown, coupled to each other. The switchboard nodes may be server computers and/or routers. The switchboard nodes may each include a security module 132 that supports a security protocol to enable secured communications between the service devices of the support network 120 and the user devices of the user network 110. By aggregating all security requirements for service products, service devices and user devices into the same security solution, supported by security modules 132, minimal changes to the firewall configurations of the user firewall 112 and the service firewall 122 may be needed in order to provide access to all product services and support services for all user devices.

The security modules 132 receive an indication of what services each of the service devices of the support network 120 can dispense. The service description given to the service modules 132 of the switchboard system 130 by the service devices may include a set of service attributes and associated security requirements. The security requirements may be different for different services, different devices, different users, etc, In other words, the interpretation of the security requirements may be dependent on one or more of the service being provided, the device type requesting the service and the identity of the user utilizing the device requesting the service.

When one of the user devices of the user network 110 connects to the switchboard system 130, the user device may present a set of identifying attributes identifying the user device and/or the user. User devices and/or users that provide more authentication details may be afforded greater access to restricted services available from the switchboard system 130. The level of access afforded to a user may depend on the identity of the user. The credibility of the identifying attributes of a user device and/or of a user may be ascertained through an analysis of aspects of the device (e.g., subnet origin, serial number, firmware revision, etc.), aspects of the user (low-level subscriber, low level employee, medium level subscriber or employee, high level subscriber or employee, etc.). Strong authentication mechanisms may be preferred but may not be necessary for access to basic switchboard functions.

In some exemplary systems, a relaxation of access control may be desirable for some low-end devices deployed in the field which may be simple ‘plug and play’ products (e.g., printers, video and/or audio players, etc.). At the other end of the spectrum, high-end devices may require user registration, geographic information, etc. Both low-end and high-end contexts may be supported simultaneously by a dynamic trust capability of the switchboard system 130.

The role of a user device and a service device discussed above may be interchangeable. Just as user devices of the user network 110 may connect to the switchboard system 130 and request updates, service, or help from a service provider device or agent, a support agent may connect to the switchboard system 130 and request logging streams as a service provided to a user device.

The switchboard system 130 may have no awareness of the content of the connections between the service devices and user devices. These connections may be treated as opaque data ‘pipes’, the interpretation of which may be dependent on product implementation, By removing constraints on the format of the content exchanged by the service devices and the user devices, the switchboard system 130 can accommodate many incompatible support protocols within the same support framework. This characteristic may be useful for integrating new products and/or services into the system 100 quickly and effectively.

Large scale implementations of the switchboard network 130 may consist of many interconnected switchboard nodes, forming a ‘cloud’ network. Services may be distributed via multiple hops between these internal switchboard nodes. User devices of the user network 110 can query the nodes of the switchboard system 130 for information on connected service providers, service devices and user devices coupled to the switchboard system 130, depending, in some exemplary systems 100, on a level of trust afforded the user device for a selected service. All switchboard nodes may present a similar Internet face to all user devices in the user network 110. This may simplify configurations of both the user firewall 112 and the support firewall 122.

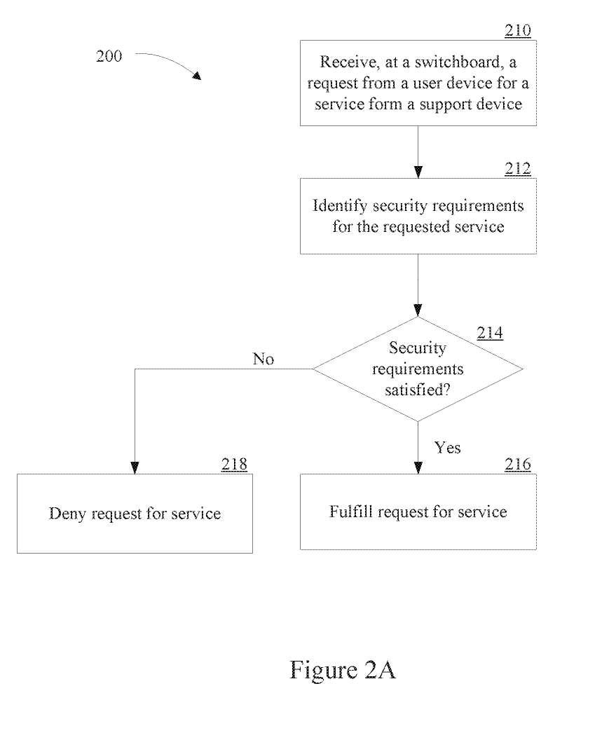

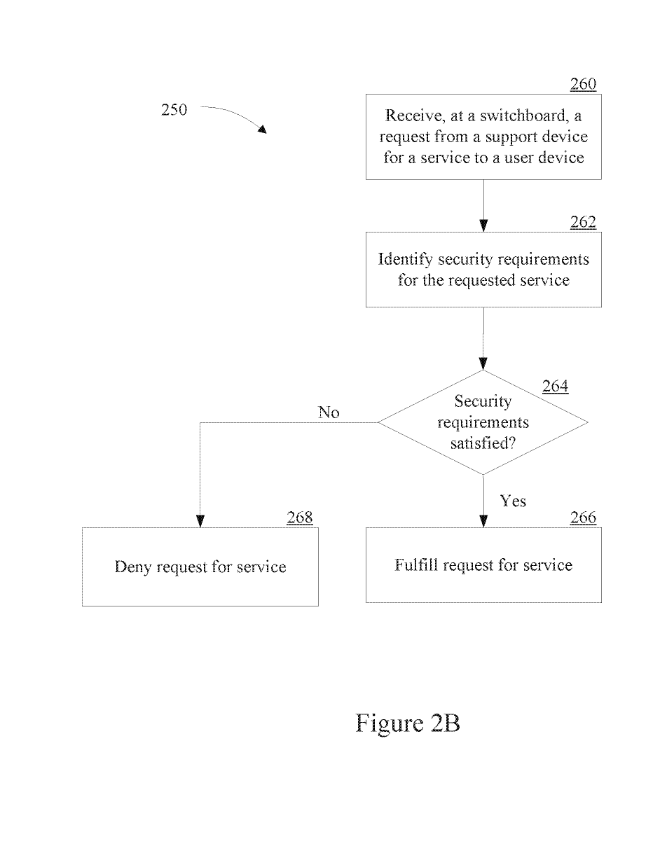

FIG. 2A illustrates an example process 200 that may be used for interconnecting consumers and producers of digital services. In various examples, the process 200 can be performed, at least in part, by various components of the system 100 as described above with reference to FIG. 1. The process 200 will be described with further references to FIG. 1.

In the example illustrated in FIG. 2A, the process 200 may begin at block 210 with one of the switchboard nodes of the switchboard system 130 receiving a request from one of the user devices of the user network 110 for a connection to a service from the support network 120. The request may be a request for a connection to a specified product or service provided by a service node of the support network 120 or to a specified support service provided by a service agent of a service device in the support network 120.

At block 212, the switchboard node identifies security requirements associated with the requested service or product. The requested service or product is one of a plurality of services or products offered by the support network 120 and the security requirements include least one security requirement from a plurality of security requirements supported by the security module 132. As discussed above, different ones of the plurality of offered services and products may be associated with different ones of the plurality of security requirements, as determined by previously agreed upon specifications provided by the user network 110 and/or the support network 120 to the switchboard system 130.

The security requirements identified at block 212 may be a simple user device identifier such as a serial number, model number, or other way of identifying the type of device requesting the service. This may allow for an anonymous connection for such simple purposes as software updates, searches, etc. Alternatively, the security requirements identified at block 212 may include both the device identifier and user credentials such as, for example, user ID, user password, employer identifier, etc. In addition, other security requirements may be identified at block 212 such as, for example, geographic location of the user device, temporal information such as time of day, week, month, and or other possible criteria. Upon identifying the security requirements at block 212, the switchboard node may pull information from the request received at block 210 or receive additional information from the user device at block 212.

In addition to requirements related to the user device and/or user credentials, the security requirements identified at block 212 may also include identifiers of service devices and/or service agents in the support network 120 that may be used to fulfill the request received at block 210. For example, a support network may restrict services provided by individual agent identifiers, agent regions, agent countries, group memberships of agents, domain address of the service device, etc. These support network restrictions may be selected differently for different products, devices, product families, model numbers of user devices, etc.

Upon identifying the security requirements associated with the requested service or product, at block 212, the process 200 continues to decision block 214 where the switchboard node determines if the identified security requirements have been satisfied. At decision block 214, the switchboard node may authenticate the request received at block 210, e.g., using an RDA (Remote Device Access) certificate and based on the security information received in the request and/or received in a separate message. The authenticated request may be signed by an RDA CA (Certificate Authority) and may therefore have a verifiable level of trust associated with the requesting user device of the user network 110. In this way, the switchboard node acts as a proxy server and may forward the request to an appropriate server in the RDA cloud.

If the security requirements associated with the requested service or product are determined to be satisfied at decision block 214, the switchboard node fulfills the request for service or product by forwarding the authenticated request to a support device in the support network 120 at block 216. If the security requirements are determined not to be satisfied, the switchboard node denies the request for service at block 218.

The process 200 is exemplary only and other embodiments may combine blocks, rearrange blocks and/or include additional blocks than those shown in FIG. 2A.

As discussed above, the request for a connection between user devices and support devices may be reversed. For example, a support device may request a connection with a user device in order to interact with a user device directly to upgrade a product or to determine a problem with a product. FIG. 2B illustrates an example process 250 that may be used for interconnecting consumers and producers of digital services where the support device is requesting the connection. The process 250 will be described with further references to FIG. 1.

In the example illustrated in FIG. 2B, the process 250 may begin with one of the switchboard nodes of the switchboard system 130 receiving a request from one of the support devices of the support network 120 for a connection to a user device from the user network 110 at block 260. The request may be a request for a connection to provide a specified service requested previously by a user device of the user network 110 or to provide a pro-active service for a user device without a previous request for service being received from a user device.

At block 262, the switchboard node identifies security requirements associated with the requested service or product to be provided with the connection. The security requirements include least one security requirement from a plurality of security requirements supported by the security module 132. As discussed above, different ones of the plurality of offered services and products may be associated with different ones of the plurality of security requirements, as determined by previously agreed upon specifications provided by the user network 110 and/or the support network 120 to the switchboard system 130.

The security requirements identified at block 262 may include a support device identifier, a support agent identifier, a user device identifier, etc. The security requirements may allow for a secure pairing of a service device or service agent and a user device or user. The security requirements identified at block 212 may depend on a previous service requested by a user during the process 200 described above. For example, a service agent or service device may be requesting a connection to a specified user device in response to a request for service previously received from the specified user device. In addition, other security requirements may be identified at block 262 such as, for example, geographic location of the user and/or service device, temporal information such as time of day, week, month, and or other possible criteria.

Upon identifying the security requirements at block 262, the switchboard node may pull information from the request received at block 260 or receive additional information from the service device and/or the associated user device at block 262.

Upon identifying the security requirements associated with the requested service or product, at block 262, the process 250 continues to decision block 264 where the switchboard node determines if the identified security requirements have been satisfied. At decision block 264, the switchboard node may authenticate the request received at block 260, e.g., using an RDA certificate and based on the security information received in the request and/or received in a separate message. The authenticated request may be signed by an RDA CA and may therefore have a verifiable level of trust associated with the requesting service device of the service network 120.

If the security requirements associated with the requested service or product are determined to be satisfied at decision block 264, the switchboard node fulfills the request for a connection to provide a service or product by forwarding the authenticated request to the specified user device in the user network 110 at block 266. If the security requirements are determined not to be satisfied, the switchboard node denies the request for service connection at block 268.

The process 250 is exemplary only and other embodiments may combine blocks, rearrange blocks and/or include additional blocks than those shown in FIG. 2B.

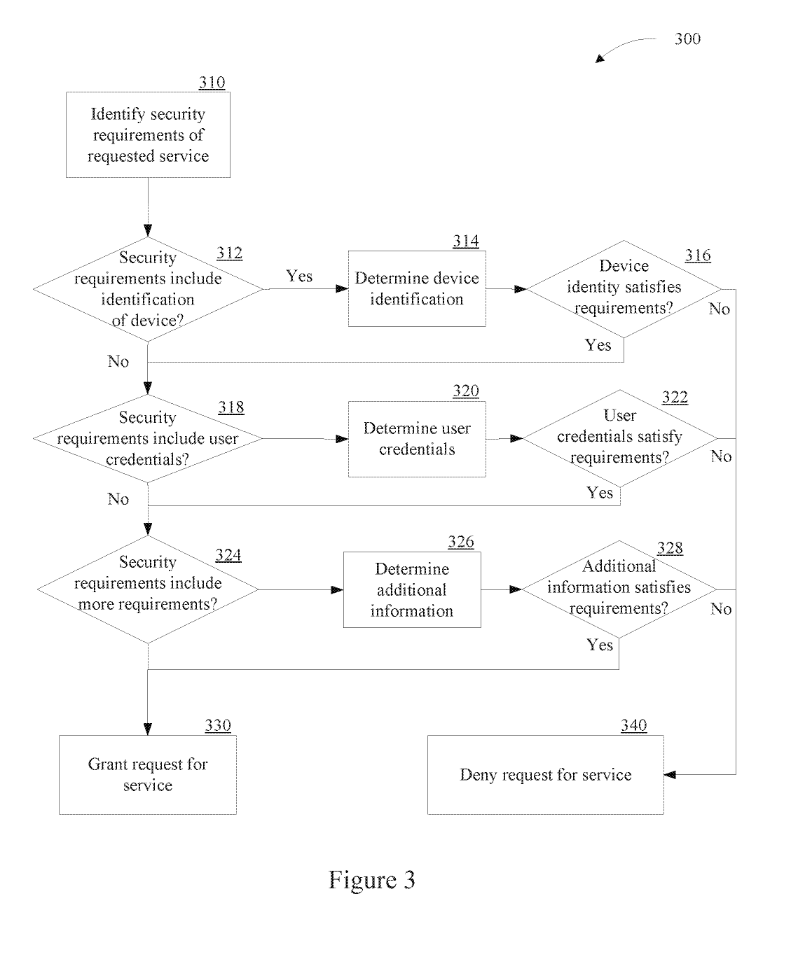

FIG. 3 illustrates example functions in a process 300 that may be performed during security requirement assessment while interconnecting consumers and producers of digital services, For example, the process 300 may be performed at decision block 214 of the process 200 or at decision block 264 of the process 250 described above. The process 300 will be described with further references to FIG. 1.

At block 310, a switchboard node of the switchboard network 130 identifies security requirements associated with a request received from a user device of the user network 110 or associated with a request from a service device of the support network 120, or both. The identification of security requirements at block 310 may be the same or different from the security requirement identifications described above in reference to blocks 212. and 262 of the processes 200 and 250 respectively.

At decision block 312, the switchboard node determines whether or not the identified security requirements include identification of a user device and/or a support device. If it is determined that device identification is required, the switchboard node determines the device identification of the user device and/or the service device at block 314. If it is determined that device identification is not required, the process 300 continues at decision block 318. The determination of device identification information at block 314 may be made based upon information received in a request for service received from a user device (e.g., at block 212 of the process 200) or from a request for a connection to a user device received from a service device (e.g., at block 262 of the process 250). The determination of device identification information at block 314 may also be made based upon additional information received in one or more additional messages received from a user device and/or a service device at block 314.

Upon determining the device identification information at block 314, the process 300 continues at decision block 316 where the switchboard node determines, based on the device identification information determined at block 314, whether or not the device identity security requirements have been satisfied. If the device identity security requirements have been satisfied, the process 300 continues at decision block 318. If the device identity security requirements have not been satisfied, the process 300 continues at block 340 where the switchboard node denies the request for service.

At decision block 318, the switchboard node determines whether or not the identified security requirements include user credentials and/or support agent credentials. If it is determined that user or support agent credentials are required, the switchboard node determines the credentials of the user of the user device and/or an agent associated with the service device at block 320. If it is determined that user or support agent credentials are not required, the process 300 continues at decision block 324. The determination of user or support agent credential information at block 320 may be made based upon information received in a request for service received from a user device (e.g., at block 21 of the process 200) or from a request for a connection to a user device received from a service device (e.g., at block 262 of the process 250). The determination of user or support agent credential information at block 320 may also be made based upon additional information received in one or more additional messages received from a user device and/or a service device at block 320.

Upon determining the user or support agent credential information at block 320, the process 300 continues at decision block 322 where the switchboard node determines, based on the user or support agent credential information determined at block 320, whether or not the user or support agent credential security requirements have been satisfied. If the user or support agent credential security requirements have been satisfied, the process 300 continues at decision block 324. If the device identity security requirements have not been satisfied, the process 300 continues at block 340 where the switchboard node denies the request for service.

At decision block 324, the switchboard node determines whether or not the identified security requirements include additional requirements such as, for example, location of the user device and/or the service device, company affiliation associated with the user and/or the support agent, etc. If it is determined that additional security requirements are required, the switchboard node determines the additional information at block 326. If it is determined that additional security requirements are not required, the process 300 continues at decision block 330 where the request for service is granted by the switchboard node. The determination of the additional information at block 326 may be made based upon information received in a request for service received from a user device at block 212 of the process 200) or from a request for a connection to a user device received from a service device (e.g., at block 262 of the process 250). The determination of additional information at block 326 may also be made based upon additional information received in one or more additional messages received from a user device and/or a service device at block 326.

Upon determining the additional information at block 326, the process 300 continues at decision block 328 where the switchboard node determines, based on the additional information determined at block 326, whether or not the additional security requirements have been satisfied. If the additional security requirements have been satisfied, the process 300 continues at block 330 where the switchboard node grants the request for service. If the additional security requirements have not been satisfied, the process 300 continues at block 340 where the switchboard node denies the request for service.

The process 300 is exemplary only and other embodiments may combine blocks, rearrange blocks and/or include additional blocks than those shown in FIG. 3.

Various examples described herein are described in the general context of method steps or processes, which may be implemented in one example by a software program product or component, embodied in a machine-readable medium, including executable instructions, such as program code, executed by entities in networked environments. Generally, program modules may include routines, programs, objects, components, data structures, etc. which may be designed to perform particular tasks or implement particular abstract data types. Executable instructions, associated data structures, and program modules represent examples of program code for executing steps of the methods disclosed herein. The particular sequence of such executable instructions or associated data structures represents examples of corresponding acts for implementing the functions described in such steps or processes.

Software implementations of various examples can be accomplished with standard programming techniques with rule-based logic and other logic to accomplish various database searching steps or processes, correlation steps or processes, comparison steps or processes and decision steps or processes.

The foregoing description of various examples has been presented for purposes of illustration and description. The foregoing description is not intended to be exhaustive or limiting to the examples disclosed, and modifications and variations are possible in light of the above teachings or may be acquired from practice of various examples. The examples discussed herein were chosen and described in order to explain the principles and the nature of various examples of the present disclosure and its practical application to enable one skilled in the art to utilize the present disclosure in various examples and with various modifications as are suited to the particular use contemplated. The features of the examples described herein may be combined in all possible combinations of methods, apparatus, modules, systems, and computer program products.

What is claimed is:

1. A system, comprising:
at least one switchboard node coupled to a network;
a first device coupled to the network for sending a request for a service, the requested service being one of a plurality of offered services;
a second device coupled to the network, wherein the request for the service is associated with the second device;
wherein each switchboard node is to:
receive the request for service;
identify security requirements associated with the requested service, the security requirements being at least one security requirement from a plurality of security requirements, wherein different ones of the plurality of offered services are associated with different ones of the plurality of security requirements;
determine that the identified security requirements are satisfied; and
fulfill the request for the service upon determining that the identified security requirements are satisfied.

2. The system of claim 1, each switchboard node further configured to:
receive security information from at least one of the first device and the second device, the security information being associated with the identified security requirements; and
determine that the identified security requirements are satisfied based on the received security information.

3. The system of claim 1, wherein the first device is a user device and the second device is a service device.

4. The system of claim 3, wherein the received security information comprises a user device identifier, and the security requirements are further identified based on a type of user device identified by the user device identifier.

5. The system of claim 4, wherein the type of user device is selected from the group consisting of a mobile device, a desk top computer, a server computer and a printer. 6, A method, comprising:
receiving a request for a service from a first device connected to a network, the request for a service being associated with a connection to a second device connected to the network;
identifying security requirements associated with the requested service, the requested service being one of a plurality of offered services and the security requirements being at least one security requirement from a plurality of security requirements, wherein different ones of the plurality of offered services are associated with different ones of the plurality of security requirements;
determining that the identified security requirements are satisfied; and
fulfilling the request for the service upon determining that the identified security requirements are satisfied.

7. The method of claim 6, further comprising:
receiving security information from at least one of the first device and the second device, the security information being associated with the identified security requirements; and
determining that the identified security requirements are satisfied based on the received security information.

8. The method of claim 6, wherein the first device is a user device and the second device is a service device.

9. The method of claim 8, wherein the received security information comprises a user device identifier, and the security requirements are further identified based on a type of user device identified by the user device identifier.

10. The method of claim 9, wherein the type of user device is selected from the group consisting of a mobile device, a desk top computer, a server computer and a printer.

11. An apparatus, comprising:
a processor; and
a memory device including computer program code, the memory device and the computer program code, with the processor, to cause the apparatus to:
receive a request for a service from a first device connected to a network, the request for a service being associated with a connection to a second device connected to the network;
identify security requirements associated with the requested service, the requested service being one of a plurality of offered services and the security requirements being at least one security requirement from a plurality of security requirements, wherein different ones of the plurality of offered services are associated with different ones of the plurality of security requirements;
determine that the identified security requirements are satisfied; and
fulfill the request for the service upon determining that the identified security requirements are satisfied.

12. The apparatus of claim 11, wherein the memory device further includes computer program code to cause the apparatus to:
receive security information from at least one of the first device and the second device, the security information being associated with the identified security requirements; and
determine that the identified security requirements are satisfied based on the received security information.

13. The apparatus of claim 11, wherein the first device is a user device and the second device is a service device.

14. The apparatus of claim 13, wherein the received security information comprises a user device identifier, and the security requirements are further identified based on a type of user device identified by the user device identifier.

15. The apparatus of claim 14, wherein the type of user device is selected from the a up consisting of a mobile device, a desk top computer, a server computer and a printer.
